(19) United States
(12) Patent Application Publication
(10) Pub. No.: US 2023/0336066 A1
(43) Pub. Date: Oct. 19, 2023

(54) Spiral Magnetic Engine

(71) Applicant: Steven William Cragar, Kirkland, WA (US)

(72) Inventor: Steven William Cragar, Kirkland, WA (US)

(21) Appl. No.: 17/721,472

(22) Filed: Apr. 15, 2022

(51) Int. Cl. H02K 53/00

(52) U.S. Cl. CPC H02K 53/00

(57) ABSTRACT

A novel magnetic engine, multifunctional, movable, customizable, convertible, scalable; housed magnetic engine; comprising of an interior offset magnetic rings mounted at the optimal distance and angle, with facing poles for the inner and outer rings to force constant flow, creating a forceful spin onto the drive shaft holding the magnetic plates into the housing; enveloped in a magnetic shielding, a glide mechanism will be used to extract the inner rings from the housing to stop the engine when needed, offering a flexible use and adaptation for need. Novel flexibility to be used as a home generator or to power anything needing constant motion with the desire of reduction in other energy sources, limitless applications in adaptation, scalable design also increases the flexibility in the use.

### FIELD OF THE INVENTION

The present invention is different from your standard electrical and fuel driven engines. It only requires magnets to keep the constant flow of motion. There were no close matches in the field to the current design, so this device will fill a hole and start a new opportunity in the market. The scope of the design was originally focused on providing an additional power supply for homes but could be adjusted to drive a wide range of mechanisms. The engine has been designed with the desire to drive down the uses of more destructive forms of energy and offering potential for off the grid power.

### BACKGROUND

A recent similar engine was found on the background search U.S. Pat. No. 11,165,307 but the difference is in the drive of combustion simulation style vs this spiral driven engine. The common engine typically uses a fuel source to drive the engine, in the case of this design a magnetic propulsion is used to keep a constant flow to the drive powering the desired process.

The common engine requires constant resupply of fuel to keep it in motion, whereas the spiral magnetic engine will provide a constant flow with occasional maintenance to keep it running. The engine could even be used in the production of more engines. This engine could have a massive impact on environmental issues that are prevalent today. This would lower our dependency on fossil fuels and other toxic environmental sources.

### SUMMARY

It is a magnetic shielded housed spiral magnetic engine, designed to replace common engines driving alternators and other desired devices, sizable, adjustable, with the facing magnetic poles being angled as close to ninety as physically possible in the build, producing optimal force, and flexibility for many needs in the market.

The housing and size could adjust for needs, aesthetics, portability, and other implementation changes as needed for use.

The engine could be weatherized for outdoor use or adapted for the use in factories or be adapted to run in boats, cars, and many other potential replacements for a constant drive to feed power to device that requires a spinning force.

Alignment pistons can also be adjusted to stabilize the engine for a variable use case. Providing longevity and investment return over time.

Locking mechanisms can be put in place to further hold and stabilize the engine during use. Preventing damage to the internal components.

### BRIEF DESCRIPTION

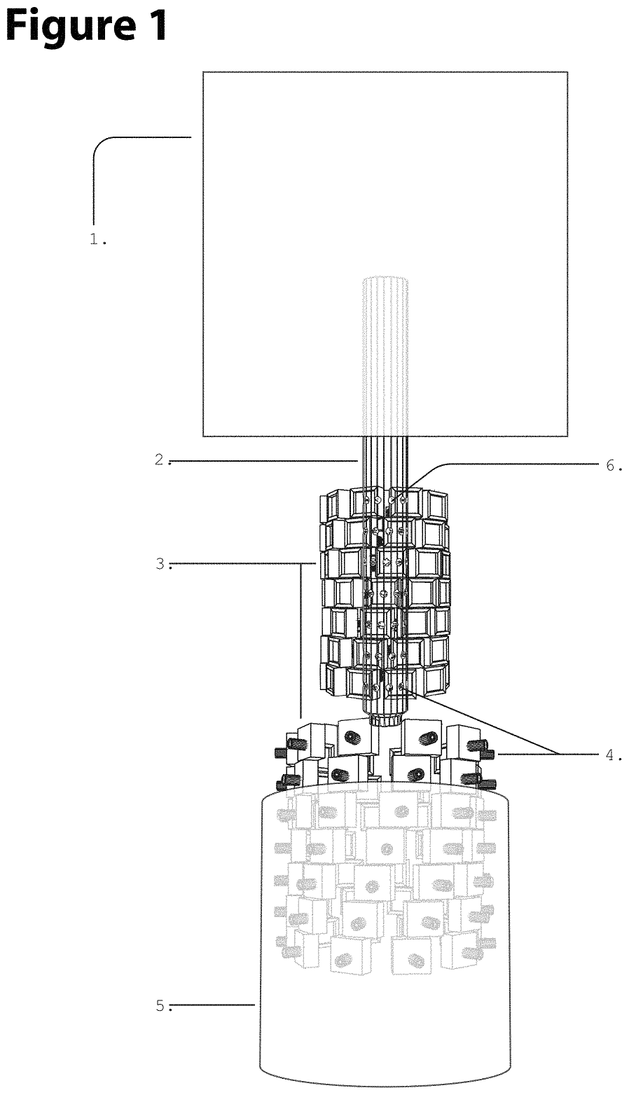

FIG. 1 is an exploded view of the unit aligned vertically. The unit's shield has been pulled up to expose the main drive holding the magnets connected to it with the support structures. Below it is the internal magnets and supports pulled slightly out of the cylindrical sleeve.

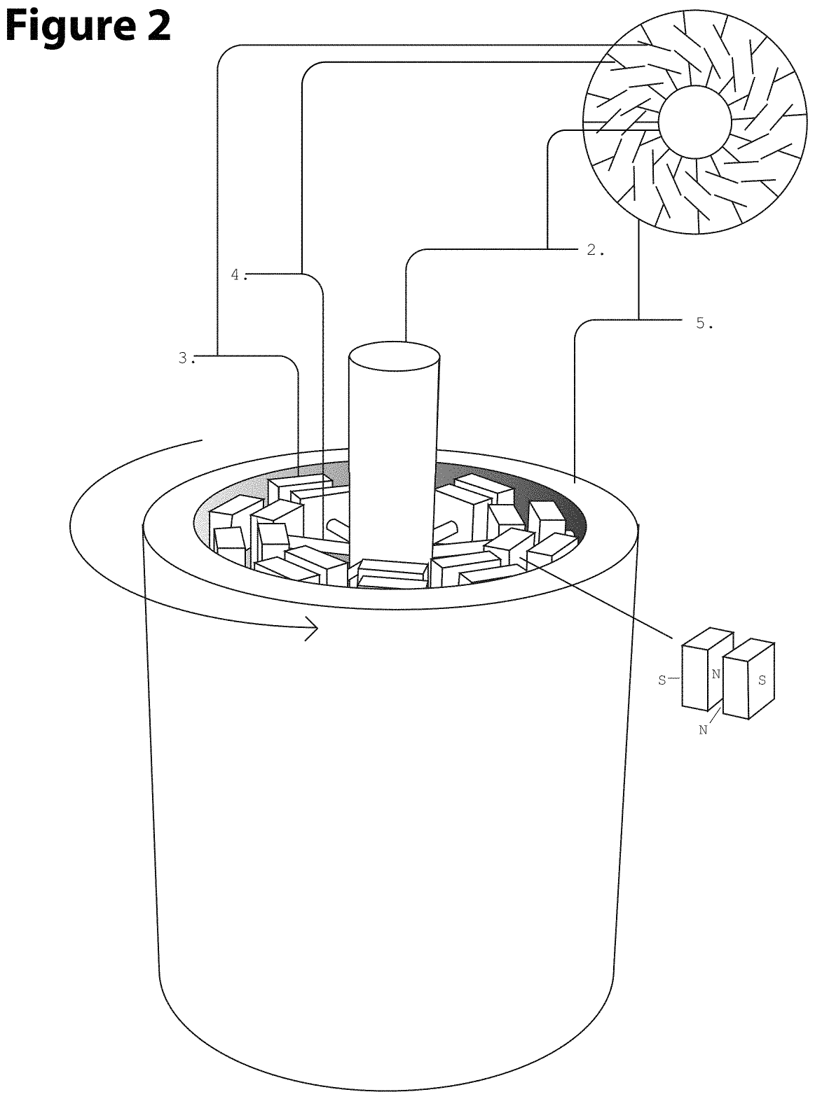

FIG. 2 shows the unit fully inserted to demonstrate the magnetic fields forcing the drive into constant motion. The small figure showing a potential of angling to cause maximum force.

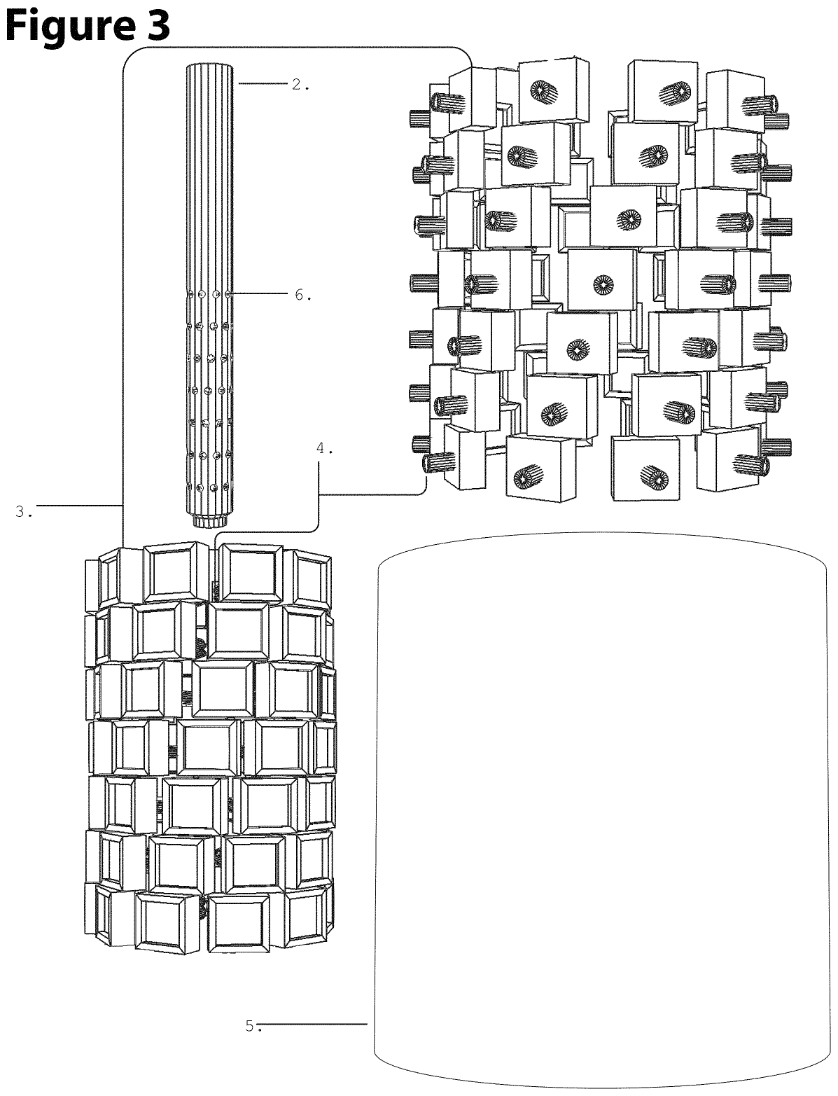

FIG. 3 is all the main drive units pulled apart for easing viewing. Each row of the magnets has been offset to maintain a constant force in the proper direction. The configuration can be adjusted for demand.

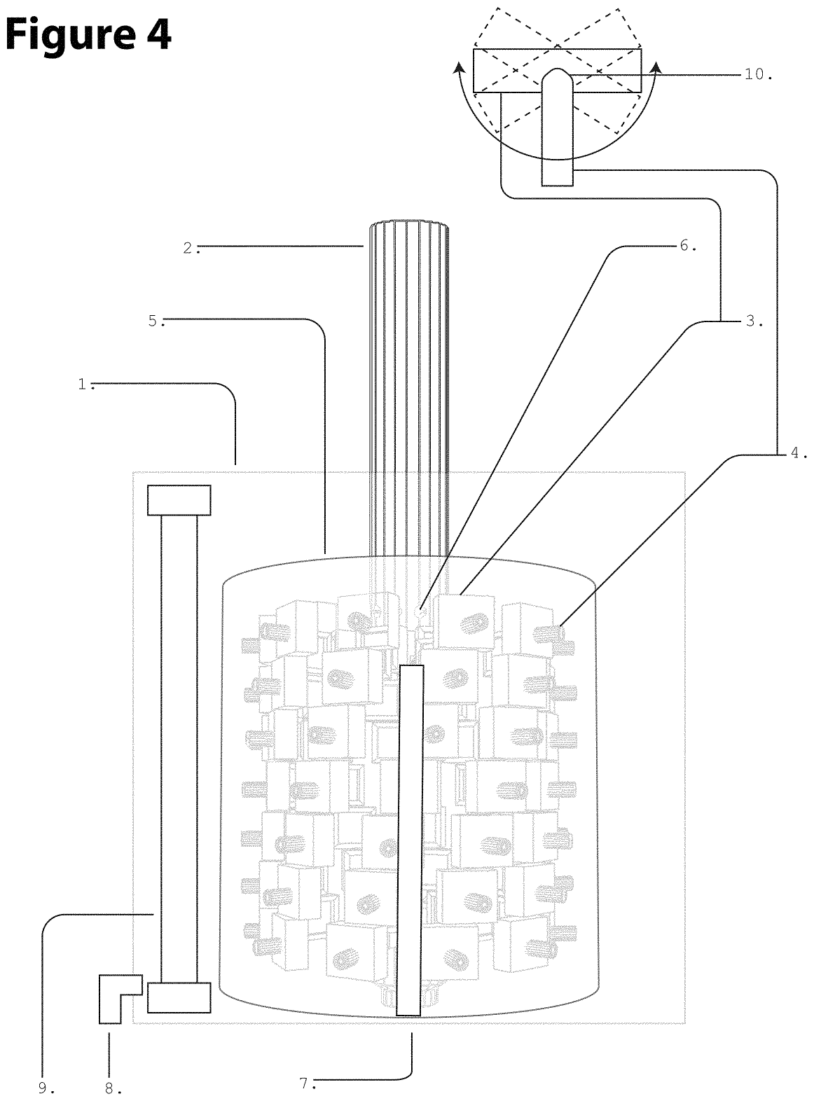

FIG. 4 is the preferred implementation set into running position. Examples of optional components to adapt to use have been added as a reference.

### DETAILED DESCRIPTION OF THE PREFERRED EMBODIMENT

Refer to FIG. 1 showing the exploded view of the preferred embodiment. The 1 magnetic shielded housing being pulled off the unit for the display will contain and protect the unit. Below it the 2 drive has also been separated to show the attachment of the 3 inner magnetic rings attached to it by the 6 support structures. Below that the 3 inner magnetic rings have been separated to show the 4 support structure attachment to the 5 inner sleeve.

Refer now to FIG. 2 displaying the unit without the 1 magnetic shield. The 2 drive is now in the running position where the facing 3 magnets can force each other perpetually causing the drive shaft to spin. The desired device that needs the power generated would be attached to the 2 drive shaft to generate the desired force from the motion.

Refer now to FIG. 3 showing all the main power units pulled apart for easy visibility. The rows of 3 magnets have been spiraled in this example to maintain a constant force in one direction.

Refer now to FIG. 4 showing a fully closed unit. The preferred embodiment would have the desired powered device connected to the 2 drive and optionally having the 1 magnetic shield surrounding the device if needed. Other recommended options like the 8 lock for the 1 magnetic shield housing should be put in place to increase the stability. A 7 alignment rod is recommended for the balance of the engine as it is taken in and out of the running position. A 9 lifting piston could also be used on the corners of the housing to ease in the disengagement and maintenance of the engine. A 10 pivoting head to prevent stasis and have additional control over the drive.

What is claimed:

1. A magnetic driven engine comprising:
a base cylindrical housing unit, wherein the inner plurality of offset angled magnets are mounted for optimal force, adjusted to the physical constraints of the preferred embodiment attached to a plurality of rotational heads, that can be triggered to prevent stasis while in operation; a cylindrical inner drive, wherein the inner plurality of angled for optimal force magnetic rows will be mounted with facing magnetic poles, attached to a plurality of rotational heads, producing a constant force on the drive shaft;
a drive shaft connection that can be adapted to run a flexible range of devices.

2. The magnetic driven engine according to claim 1, further comprising of a customizable housing unit, offering protection, and shielding for the desired powered device and engine.

3. The magnetic driven engine according to claim 1, further comprising of suggested locking and lifting units for safety during operation, ease of maintenance and disengagement of the unit, an alignment rod or piston to increase the stability and longevity of the components wherein.
